(19) United States
(12) Patent Application Publication
(10) Pub. No.: US 2006/0002722 A1
(43) Pub. Date: Jan. 5, 2006

(54) System and method for detecting a life time of a developer

(75) Inventor: Hiroshi Murata, Kanagawa-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/880,592

(22) Filed: Jul. 1, 2004

(51) Int. Cl. G03G 15/08

(52) U.S. Cl. 399/27

(57) ABSTRACT

A device for detecting a life of a developer that is used in an image forming apparatus includes a sensor that detects a toner density of the developer and provides an output. The device also includes a control unit, coupled to the sensor, that is configured to determine a toner density recovery time, the toner density recovery time being a length of time from a first time that a new toner source is added to the image forming apparatus to a second time that the sensor output reaches a predetermined value. The control unit determines whether the developer has reached a predetermined replacement point based on the toner density recovery time.

### FIELD OF THE INVENTION

The present invention relates to an image forming apparatus. More particularly, the present invention relates to a system and method for detecting a life time of a developer in an image forming apparatus.

### BACKGROUND OF THE INVENTION

Image forming apparatuses, such as printers and photocopiers, typically use a developer to reproduce original images on a document. The developer includes a carrier and toner. The carrier is a charged particle that supports the toner and delivers the toner to a developing roller for application to a document on which the original image is being reproduced. As the hardcopy device operates over time, the supply of toner is used up, and a replacement of the toner, such as with a toner cartridge, is needed to continue operation.

Further, the fluidity of the carrier, which is a measure of the ability of the carrier to transport the toner, diminishes after repeated replacements of toner. Several factors cause this reduction in fluidity, including, for example, the stress applied to the carrier due to friction with rollers in the developer unit, the carrier losing its charge, and the actual carrying of toner particles by the carrier. Due to the reduction of the fluidity, the carrier itself must eventually be replaced. The time between carrier replacements can be referred to as the developer life.

One known method for determining when to replace the carrier is to use a toner density sensor, which measures toner density in the developer unit. In particular, the toner density is a measurement of the carrier divided by the sum of the carrier and the toner. The sensor is typically located in the developer unit downstream from the toner cartridge. In conventional systems, the end of the developer life is detected when the fluctuations of the toner density output exceed a threshold level.

### SUMMARY OF THE INVENTION

Briefly, in one aspect of the invention, a system and method for detecting a life of a developer that is used in an image forming apparatus includes a sensor that detects a toner density of the developer and provides an output. The device also includes a control unit, coupled to the sensor, that is configured to determine a toner density recovery time, the toner density recovery time being a length of time from a first time that a. new toner source is added to the image forming apparatus to a second time that the sensor output reaches a predetermined value. The control unit determines whether the developer has reached a predetermined replacement point based on the toner density recovery time.

Further features, aspects and advantages of the present invention will become apparent from the detailed description of preferred embodiments that follows, when considered together with the accompanying figures of drawing.

### BRIEF DESCRIPTION OF THE DRAWINGS

The accompanying drawings, which are herein incorporated and constitute a part of this specification, illustrate embodiments of the invention and together with the description serve to explain principles of the invention.

FIG. 1 is a block diagram of an image forming apparatus consistent with the present invention.

FIGS. 2A and 2B are illustrations of a side view and a top view, respectively, of a developing device consistent with the present invention.

FIG. 3 is a block diagram of a developer life discrimination device consistent with the present invention.

FIG. 4 is a graphical illustration of exemplary changes in toner density after different toner cartridge replacements consistent with the present invention.

FIG. 5A is a graphical illustration of exemplary changes in toner density after different toner cartridge replacements based on reaching a predetermined toner density consistent with the present invention.

FIG. 5B is a graphical illustration of exemplary changes in toner density after different toner cartridge replacements based on reaching a predetermined time consistent with the present invention.

FIG. 6 is a graphical illustration of exemplary changes in toner density at a predetermined time after each toner cartridge replacement consistent with the present invention.

FIG. 7 is a graphical illustration of exemplary changes in toner density after each toner cartridge replacement accounting for operating conditions and predicting developer life consistent with the present invention.

### DETAILED DESCRIPTION OF PREFERRED EMBODIMENTS

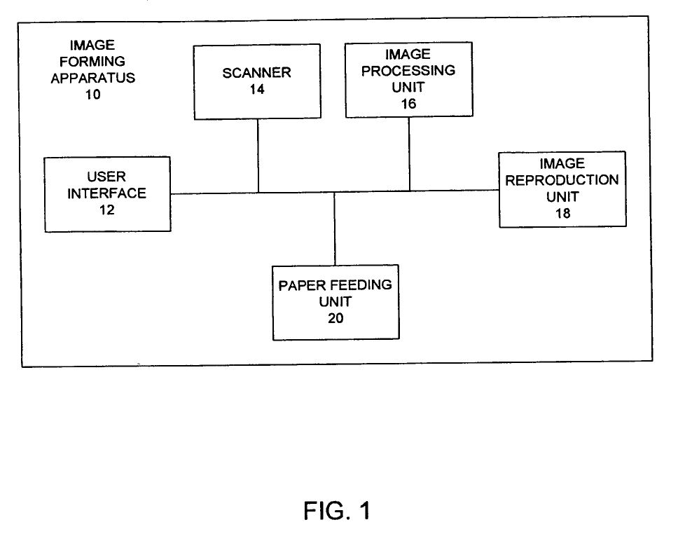

FIG. 1 is a block diagram of an image forming apparatus consistent with the present invention. As shown in FIG. 1, an image forming apparatus 10 includes a user interface 12, a scanner 14, an image processing unit 16, an image reproduction unit 18, and a paper feeding unit 20. The image forming apparatus 10 can be, for example, a copier, a multi-function peripheral or printer (MFP). In addition, the image forming apparatus can be a black and white (B/W) or a color device.

The user interface 12 is an interface through which a user can input information to the image forming apparatus 10. The information input through the user interface 12 includes settings of a copy job, such as number of copies, paper size, enlargement/reproduction amount, etc. The user interface 12 can be implemented, for example, as a touch screen, an LCD display with corresponding buttons, or other configuration enabling a user to establish the settings of a copy job. The display of the user interface 12 can also provide information about the operations and status of the image forming apparatus 10.

The scanner 14 scans original images from documents placed on a document table of the image forming apparatus 10. The documents can be placed on the document table, which is typically a glass plate, with an automatic document feeder (ADF) or by hand. The scanner 14 includes a light source, such as a lamp, that scans light across the document. The light reflected by the document is directed to a light detecting sensor, which converts the detected light into digital image data. The light detecting sensor can be implemented as a charge-coupled device (CCD).

The image data generated by the light detecting sensor of the scanner 14 is processed by the image processing unit 16. The image processing unit 16 can be configured to perform a variety of image processing functions. For example, the image processing unit 16 can perform image data conversion, gamma correction, compression, density adjustment, range compensation, halftone processing, dithering, error diffusion, smoothing, filtering, enlargement/reduction or other image processing functions.

The processed image data from the image processing unit 16 is used by the image reproduction unit 18 to reproduce the scanned original image from the document onto a copy paper. The image reproduction unit 18 can include an ink source, such as a developer or ink, an image generating unit for generating a latent image from the processed image data, an image transfer unit for transferring the latent image to the copy paper and a fusing unit for fusing the image to the copy paper. The ink source can include a developing device or unit, which includes developer for providing toner of a particular color. If the image forming apparatus 10 is a color device, there can be a separate developing device for each toner color, such as black, cyan, magenta, and yellow.

The copy paper is provided to the image reproduction unit 18 using a paper feeding unit 20. The paper feeding unit 20 can include one or more cassettes holding one or more sizes of copy paper and transfer mechanisms for transferring the copy paper from the cassettes to the image reproduction unit 18. The paper feeding unit 20 can also include a manual feed portion that enables a user to feed variably sized paper to the image reproduction unit 18.

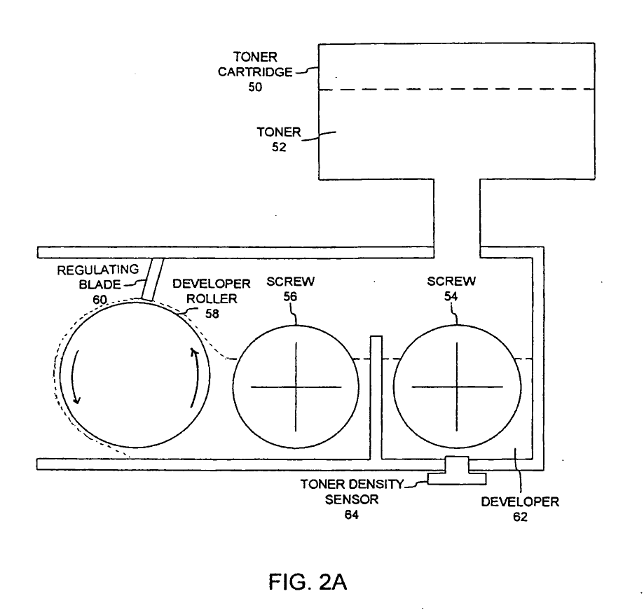

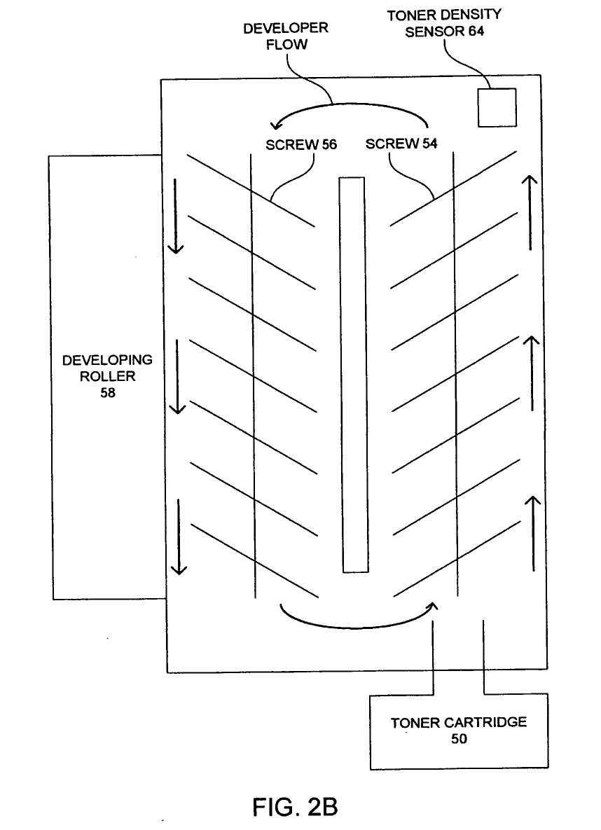

FIGS. 2A and 2B are illustrations of a side view and a top view, respectively, of a developing device consistent with the present invention. The developing device can be a component of the image reproduction unit 18. As shown in FIG. 2A, the developing device includes a toner cartridge 50 holding toner 52, a pair of screws 54 and 56, a developing roller 58, a regulating blade 60, developer 62 and a toner density sensor 64. The toner cartridge 50 can be a container or bottle made of any suitable material, such as plastic, for holding the toner 52. The toner cartridge 50 supplies the toner 52 to the developer 62.

The screws 54 and 56 generate a flow in the developer 62 and provide the developer 62 to the developing roller 58. Instead of the screws 54 and 56, the developing device can use alterative elements, such as mixers, that are capable of moving the developer 62 toward the developing roller 58. The developing roller 58 provides the toner 52 in the developer 62 to a component of the image transfer unit of the image reproduction unit 18, such as a photoelectric transfer drum or a transfer belt. The regulating blade 60 regulates an amount of developer on the surface of the developing roller 58. For example, the regulating blade 60 may regulate the amount of developer so that an approximately uniform amount of developer is on the surface of the developing roller, as shown in FIG. 2A.

As shown in FIG. 2B, the toner cartridge 50 provides the toner 52 to the developer 62 at one end of the screw 54. The rotation of the screw 54 leads the developer 62 to the other end of screw 54 at which the toner density sensor 64 is located. The toner density sensor 64 is preferably located away from the toner cartridge 50 to improve the accuracy of the toner density measurement. The toner density sensor 64 can be, for example, a permeability sensor. The output of the toner density sensor 64 is a value indicative of the toner density, and can be represented, for example, as a voltage value. The screw 56 generates a flow of the developer 62 in a direction opposite to the screw 54. In total, the flow of the developer 62 is generally circular, flowing in one direction with the screw 54, flowing in the opposite direction with the screw 56, and back again. The developer 62 flowing with the screw 56 is also supplied to the developing roller 58.

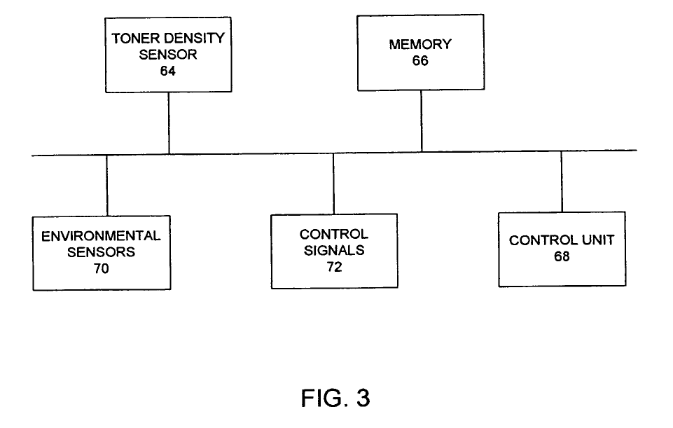

FIG. 3 is a block diagram of a developer life discrimination device consistent with the present invention. As shown in FIG. 3, the developer life discrimination device includes the toner density sensor 64, a memory 66, a control unit 68, environmental sensors 70 and control signals 72. The control unit 68 can include, for example, a processor, such as a CPU or microprocessor, or any other or form of processing unit capable of processing data and outputting results indicative of the processing. The control unit 68 can also include a dedicated memory or cache comprising instructions executed by the processor.

The memory 66 is preferably configured to store data output from the toner density sensor 64, the control unit 68, and the environmental sensors 70. The memory 66 can also store the instructions executed by the processor of the control unit 68. The memory 66 can be implemented, for example, as a RAM, NVRAM or EPROM. The environmental sensors 70 includes sensors capable of detecting one or more environmental conditions in which the image forming apparatus 10 and/or the developing device is operating, such as temperature, pressure, and humidity.

In operation, the outputs of the toner density sensor 64 and the environmental sensors 70 are received by the control unit 68. Their outputs can also be stored in the memory 66. Based on these sensor outputs, the control unit 68 is configured to determine or discriminate the life of the developer 62. To determine the life of the developer, the control unit 68 is configured to use the sensor outputs at various different points including, for example, as follows: the time at which the toner cartridge 50 is replaced, the time when the developing device in the image forming apparatus 10 begins operating after installing a new toner cartridge 50, a predetermined time after the replacement of the toner cartridge 50 or commencement of operation of the developing device, the time the toner density reaches a predetermined level, and the time the toner density reaches a normal operating level.

The control unit 68 uses one or more of these detected toner density levels and the times that they are detected to determine the life of the developer 62. The control unit 68 also stores the detected toner density levels and the times at which they are detected in the memory 66. In addition, based on the time and toner density data, the control unit 68 generates the control signals 72. The control signals 72 utilize the results of the analysis by the control unit 68 and indicate, for example, whether or not the developer 62 needs to be replaced, a prediction of how much life the developer 62 has left, the toner density output from the toner density, the amount of time it took the toner density to reach a certain level, and any other relevant information that can be derived from the toner density sensor 64 and the environmental sensors 70. The indications provided by the control signals 72 can be displayed by the image forming apparatus 10, such as on the LCD display of the user interface 12. It is also possible for the control signals 72 to be provided to a maintenance person or network administrator, such as by an e-mail message.

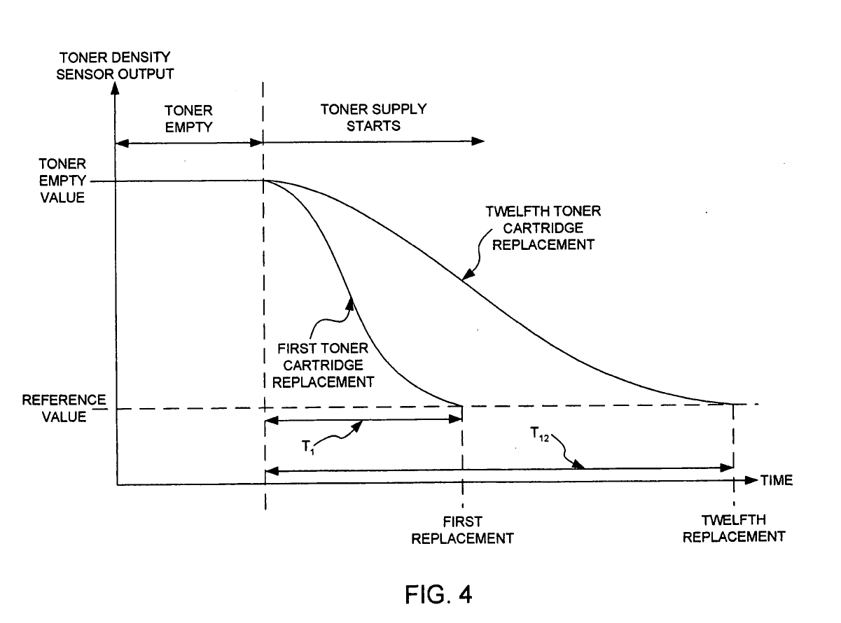

FIG. 4 is a graphical illustration of exemplary changes in toner density after a number of toner cartridge replacements consistent with the present invention. As shown in FIG. 4, the graph illustrates the changes in toner density when the toner is empty, when the toner is replaced after the first replacement, and after the twelfth replacement. When the toner is empty, the toner density value output from the toner density sensor 64 is at a relatively constant level. In normal operation, one typical value when the toner is empty is about 3.0 volts.

After the first replacement of the toner cartridge 50, the toner density drops to a reference value. This reference value corresponds to a normal operating toner density value, and can be, for example, approximately 2.5 volts. The time T₁, which can be referred to as a toner density recovery time, corresponds to the time it takes for the toner density output to reach the reference value after the first replacement of the toner cartridge 50. Alternatively, instead of starting the time measurement from the time that the toner cartridge 50 is replaced, the time T₁ may correspond to the time it takes for the toner density output to reach the reference value after the developing device begins operation with the new toner cartridge 50. For reasons of simplicity, the following description will generally refer to the time measurement beginning from the time of replacement of the toner cartridge 50. It should be understood, however, that the beginning of the time measurement can also be from the time the developing device begins operation after the replacement without departing from the present embodiment.

As further shown in FIG. 4, the toner density also drops to a reference value after the twelfth replacement of the toner cartridge 50. The time T₁₂ corresponds to the time it takes for the toner density output to reach the reference value after the twelfth replacement of the toner cartridge 50. The time T₁₂ is greater than the time T₁, meaning that it took longer to reach the reference value, i.e., the normal operating toner density value, after the twelfth replacement as compared with the first replacement. This increase in time between the first and twelfth replacements reflects the weakening of the carrier and a reduction of the fluidity of the developer 62.

The time between the replacement of the toner cartridge 50 and reaching the reference value can be used to determine whether or not the developer 62 needs to be replaced. If the time is greater than a predetermined threshold, then the life of the developer 62 is determined to be over. In other words, when the time is greater than a predetermined threshold, the developer should be replaced and has reached a predetermined replacement point. The predetermined threshold generally depends upon the type of developer 62 being used and may be adjusted through the user interface 12 to a different setting. In general, the predetermined threshold can be set to some time between about 100 and 150 seconds, and more preferably to about 100 seconds. In other words, when it takes at least 100 seconds to reach the reference value from the point of replacing the toner cartridge, the developer is deemed to have reached the end of its useful life.

With reference to FIG. 4, the time T₁ may be 30 seconds, and the time T₁₂ may be 105 seconds. If the predetermined threshold is 100 seconds, then the control unit 68 would determine that the life of the developer 62 is over after the twelfth replacement of the toner cartridge 50. To indicate the need to replace the developer 62, the control unit 68 generates a control signal 72 that provides an indication on the display of the image forming apparatus 10 or creates an e-mail to indicate the need for the replacement (or other form of notification such as display on a central website). The indication may be generated, for example, at the time the determination is made or after the toner cartridge 50 becomes empty.

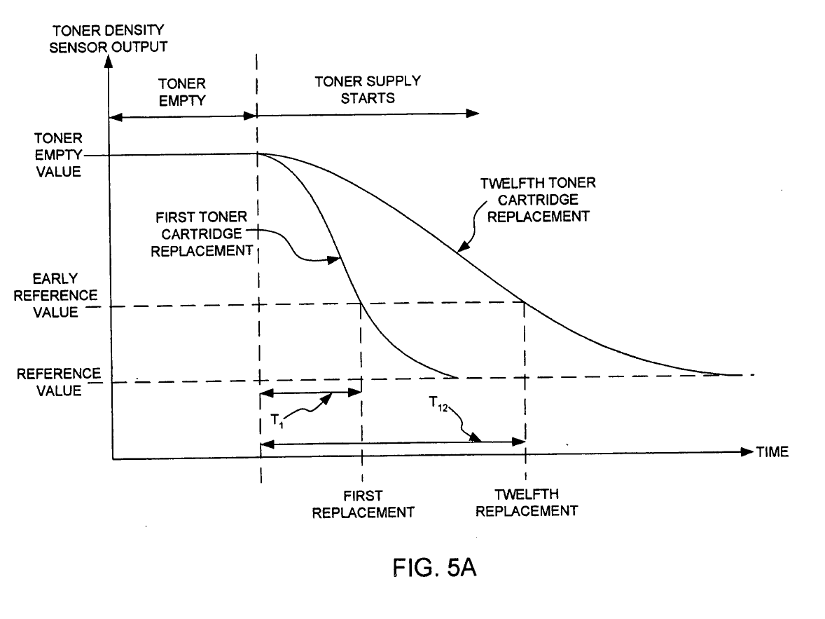

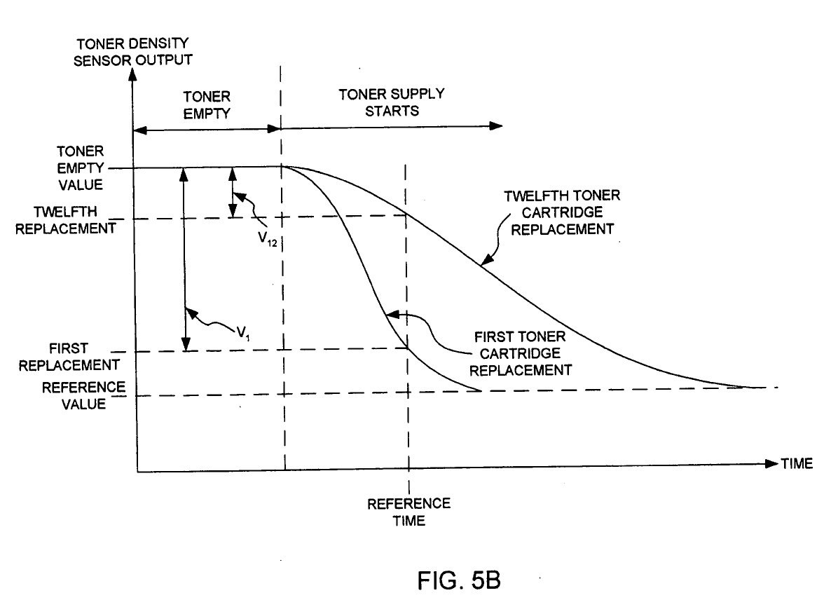

FIG. 5A is a graphical illustration of exemplary changes in toner density after different toner cartridge replacements based on reaching a predetermined toner density consistent with the present invention. FIG. 5A is similar to FIG. 4, with the exception that FIG. 5A further includes an early reference value. The early reference value corresponds to a toner density value between the reference value of FIG. 4, which relates to the normal operating toner density of the developer 62, and the toner density value when the toner is empty. The early reference value can be, for example, about 2.7 volts or 2.8 volts.

The times T₁ and T₁₂ in FIG. 5A correspond to the time between the first and twelfth replacement, respectively, of the toner cartridge 50 and the output of the toner density sensor reaching the early reference value. Like the times for reaching the reference value of FIG. 4, the time T₁₂ for reaching the early reference value is greater than the time T₁. Further, the time between the replacement of the toner cartridge 50 and reaching the early reference value can also be used to determine whether or not the developer 62 needs to be replaced. If the time for reaching the early reference value is greater than a predetermined threshold, then the life of the developer 62 is determined to be over and the developer 62 should be replaced. Since the early reference value is reached before the reference value of FIG. 4, the predetermined threshold for reaching the early reference value is preferably set to be a shorter time, such as between about 30 and 60 seconds, and more preferably to about 30 seconds.

With reference to FIG. 5A, the time T₁ may be 10 seconds, and the time T₁₂ may be 35 seconds. If the predetermined threshold for reaching the early reference value is 30 seconds, then the control unit 68 would determine that the life of the developer 62 is over after the twelfth replacement of the toner cartridge 50 based on the early reference value. To indicate the need to change the developer 62, the control unit 68 generates a control signal 72 that provides an indication on the display of the image forming apparatus 10 or creates an e-mail to indicate the need for the change (or other form of notification such as a central website). The indication can be generated at the time the determination is made or after the toner cartridge 50 becomes empty.

FIG. 5B is a graphical illustration of exemplary changes in toner density after different toner cartridge replacements based on reaching a predetermined time consistent with the present invention. The graphical illustration of FIG. 5B is also similar to that of FIGS. 4 and 5A. However, instead of having a reference value corresponding to a particular value of the toner density sensor 64, the graphical illustration of FIG. 5B includes a reference time. The reference time corresponds to a particular time after the replacement of the toner cartridge 50 (or after the developing device begins to operate after replacement). The reference time can be, for example, between about 10 to 30 seconds, and more preferably about 10 seconds. At the reference time, the value of the toner density sensor 64 is detected by the control unit 68.

Under this approach, the toner density V₁ corresponds to the toner density value of the toner density sensor at the reference time after the first replacement of the toner cartridge 50, and toner density V₁₂ corresponds to the toner density value of the toner density sensor at the reference time after the twelfth replacement of the toner cartridge 50. Alternatively, as shown in FIG. 5B, the toner densities V₁ and V₁₂ may be the difference between the toner density value when the toner is empty and the toner density at the reference time after the first and twelfth replacements, respectively.

The density values V₁ and V₁₂ are compared to a threshold to determine if the life of the developer 62 is over. If the magnitude of the toner density value at the reference time is used for the density values V₁ and V₁₂, then the threshold can be, for example, between about 2.85 and 2.95 volts, and more preferably about 2.9 volts. If the density value is greater than the threshold, then the developer 62 needs to be replaced. For example, if the reference value is 2.9 volts, and V₁₂ is 2.92 volts, then the developer 62 needs to be replaced after the twelfth replacement.

Alternatively, if the density values correspond to the difference between the values when the toner is empty and at the reference time is used, then the threshold can be, for example, between about 0.05 and 0.15 volts, and more preferably about 0.1 volts. In this case, if the density value is less than the reference value, then the developer 62 needs to be replaced. For example, if the reference value is 0.1 volts, and V₁₂ is 0.08 volts, then the developer needs to be replaced after the twelfth replacement.

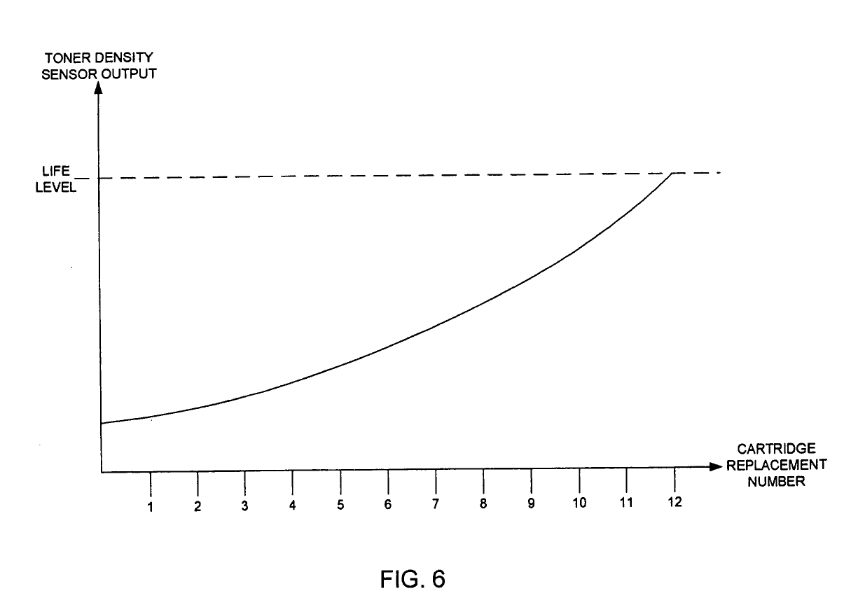

FIG. 6 is a graphical illustration of exemplary changes in toner density at a predetermined time after each toner cartridge replacement consistent with the present invention. The graphical illustration of FIG. 6 is derivative of the graphical illustration of FIG. 5B. In particular, the graph of FIG. 6 illustrates the density value of the toner density sensor 64 at a reference time after each toner cartridge replacement. The graph shows that the density value generally rises after each toner cartridge replacement. The life level, as shown in FIG. 6, corresponds to the reference value of FIG. 5B, and can be, for example, about 2.9 volts. In addition, in this example, a reference time of 10 seconds is employed, as in the example of FIG. 5B.

As described above with respect to FIG. 5B, the control unit 68 can determine that the developer 62 needs to be replaced when the toner density value after the replacement of a toner cartridge 50 exceeds the life level. As shown in FIG. 6, at the twelfth replacement, the toner density value, which has been detected by the control unit 68 at the reference time after the replacement of the toner cartridge 50, reaches/exceeds the life level. As such, the developer 62 needs to be replaced at this time.

In each of the prior examples described above with respect to FIGS. 4-6, a time or toner density value is compared to some threshold after the replacement of a toner cartridge 50 with a new toner cartridge to determine whether the developer 62 needs to be replaced. It is also possible to use the data collected after the replacements to make predictions about which replacement of the toner cartridge 50 will require the developer 62 to be replaced. In addition, the collected data can be adjusted to take into account environmental factors that may affect the values of the collected data.

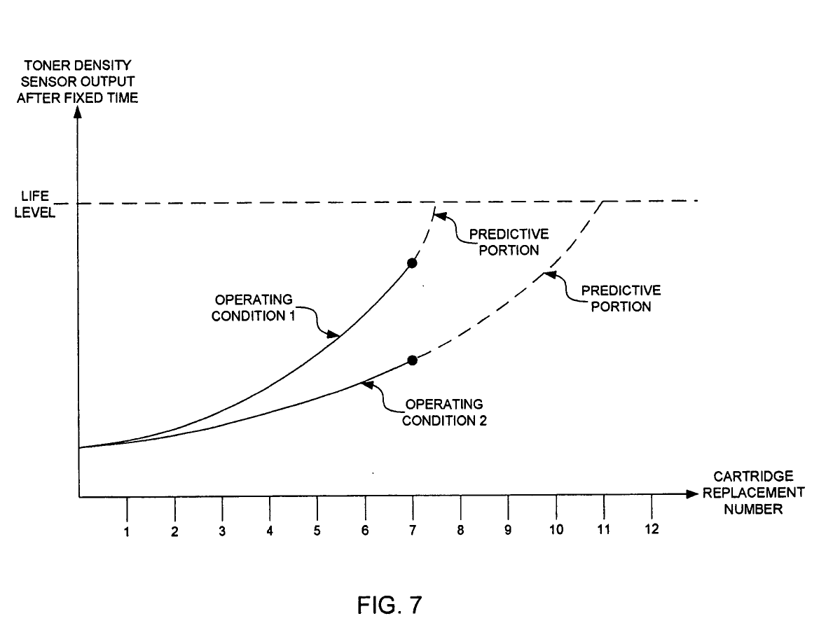

FIG. 7 is a graphical illustration of exemplary changes in toner density after each toner cartridge replacement, further accounting for operating conditions and predicting developer life, consistent with the present invention. The format of the graphical illustration of FIG. 7 is similar to that of FIG. 6, showing the output of the toner density sensor 64 at a predetermined or fixed time after each replacement of a toner cartridge 50. In this case, however, the values from each replacement are used as a basis for predicting when the toner density detected at some predetermined time will surpass the life level, which enables the control unit 68 to identify after which replacement of the toner cartridge 50 that the developer 62 will need to be changed in advance.

As described above, after each replacement of a toner cartridge 50, the control unit 68 can store the detected toner density in the memory 66 (such as at a predetermined time). The control unit 68 can reference these stored toner densities to make a prediction as to after which replacement of the toner cartridge 50 that the developer 62 will need to be changed. To make this prediction, the control unit 68 can perform a regression analysis based on the stored data to identify when the detected toner density will exceed the life level. It is also possible to calculate a slope derived from the most recently detected toner densities, and to use the slope to identify when the detected toner density will exceed the life level. For example, if the detected toner density for the fourth replacement is 2.77 volts and the detected toner density for the third replacement is 2.75 volts, then the slope would be 0.02 volts per replacement. Using that slope and assuming a life level of 2.9 volts, the control unit would predict the need to replace the developer 62 after the eleventh replacement as that replacement would have a detected toner density of 2.91 volts based on the determined slope. It should be understood that prediction of when the replacement of the developer 62 is needed can also be determined based on the times for reaching a reference level, such as described with reference to FIGS. 4 and 5A, and not just based on the toner density detected at a predetermined time.

The control unit 68 can also make predictions as to when the developer 62 needs to be replaced based on characteristics of the image forming apparatus. Such a prediction can be made at the time of the first toner cartridge replacement. For example, a time factor Ft and a voltage factor Fᵥ for a particular image forming apparatus can be determined by experiment and stored in the memory 66. After the first toner cartridge replacement, the time factor Fₜ can be multiplied by the time T₁ (shown in FIG. 4) to determine a threshold value for time. In a subsequent toner cartridge replacement, if it takes longer than the threshold value for time to reach the toner density reference value from the point of replacing the toner cartridge, the developer 62 is deemed to have reached the end of its useful life. In an exemplary embodiment, the time factor Fₜ is in the range of approximately 2 to 3. Similarly, the voltage factor Fᵥ can be multiplied by the density value V₁ (shown in FIG. 5B) to determine a threshold value for voltage. In a subsequent toner cartridge replacement, if the difference between the toner empty value and the toner density sensor value at the reference time is less than the threshold value for voltage, the developer 62 is deemed to have reached the end of its useful life. In an exemplary embodiment, the voltage factor Fᵥ is in the range of approximately ¼ to ⅓. The life judgment value, for predicting life of toner, can be done in one replacement.

In addition to making predictions as to when the developer 62 needs to be replaced, the control unit 68 can also take into account environmental conditions. As described above, the environmental sensors 70 can detect various environmental conditions, such as temperature, pressure, and humidity. The environmental conditions 70 can affect both the operation of the toner density sensor 64 and the ability of the carrier to hold the toner 52. For example, higher temperatures may cause the toner density sensor 64 to output higher toner density values than under normal operating conditions. Further, an increase in humidity may diminish the ability of the carrier to hold the toner 52, thus causing the toner density values output by the toner density detector 64 to be higher than normal.

Understanding the effects of the environmental conditions on the toner density sensor 64 and the developer 62 allows the control unit 68 to normalize the detected toner density values. To be able to normalize the detected toner density values, the control unit 68 can refer to tables that identify how the detected toner density value should be adjusted taking into account the environmental conditions detected by the environmental sensors 70. The tables can be developed, for example, by performing testing at varying environmental settings and recording how the changes in environmental settings affect the detected toner density values. The tables can be stored in a dedicated memory within the control unit 68 or stored in a separate storage area, such as the memory 66. After normalizing the detected toner density values, the control unit 68 can store the normalized values in the memory 66. By normalizing the detected toner density values, the control unit 68 is capable of more accurately determining when the developer 62 should be replaced.

As shown in FIG. 7, two data examples are shown as Operating Condition 1 and Operating Condition 2. Operating Condition 1 corresponds to the raw data output by the toner density sensor 64 that has not been normalized by the control unit 68. Operating Condition 2 corresponds to the normalization of the raw data output by the toner density sensor 64 based on the environmental conditions detected by the environmental sensors 70. For example, if the temperature and humidity detected by the environmental sensors 70 are high in comparison to normal operating conditions for Operating Condition 1, then it may be expected that the toner density values output by the toner density sensor 64 would be higher as well. Taking this into account, the normalized values would result in a data example resembling Operating Condition 2.

As described above, it is possible to determine the life of the developer 62 based on the toner densities detected at predetermined times and based on the times it takes to reach a predetermined toner density. It is also possible, based on this data, to predict when the developer 62 will need to be replaced, as well as to account for the environmental conditions that may affect the time and toner density data.

The foregoing description of a preferred embodiment of the invention has been presented for purposes of illustration and description. Of course, the various steps of detecting text, background, graphical and picture regions can be done in any order. It is not intended to be exhaustive or to limit the invention to the precise form disclosed, and modifications and variations are possible in light in the above teachings or may be acquired from practice of the invention. The embodiments were chosen and described in order to explain the principles of the invention and as practical application to enable one skilled in the art to utilize the invention in various other embodiments and with various modifications are suited to the particular use contemplated. It is intended that the scope of the invention be defined by the claims appended hereto and their equivalents.

What is claimed is:

1. A device for detecting a life of a developer that is used in an image forming apparatus, comprising:
a sensor that detects a toner density of the developer and provides an output;
a control unit, coupled to the sensor, configured to determine a toner density recovery time, the toner density recovery time being a length of time from a first time that a new toner source is added to the image forming apparatus to a second time that the sensor output reaches a predetermined value, and to determine whether the developer has reached a predetermined replacement point based on the toner density recovery time.

2. The device for detecting a life of a developer for an image forming apparatus of claim 1, wherein the control unit is further configured to conclude that the developer has reached the replacement point if the toner density recovery time exceeds a threshold value.

3. The device for detecting a life of a developer for an image forming apparatus of claim 2, wherein the predetermined value is an operating toner density value, and the threshold value is a value in the range of about 100 seconds to 150 seconds.

4. The device for detecting a life of a developer for an image forming apparatus of claim 2, wherein the predetermined value is an operating toner density value, and the threshold value is a value determined by multiplying a time factor by a toner density recovery time of a first toner source.

5. The device for detecting a life of a developer for an image forming apparatus of claim 4, wherein the time factor is in the range of about 2 to 3.

6. The device for detecting a life of a developer for an image forming apparatus of claim 3, wherein the predetermined value is about 2.5 volts.

7. The device for detecting a life of a developer for an image forming apparatus of claim 2, wherein the threshold value is approximately 100 seconds.

8. The device for detecting a life of a developer for an image forming apparatus of claim 7, wherein the predetermined value is about 2.7 to 2.8 volts.

9. The device for detecting a life of a developer for an image forming apparatus of claim 2, wherein the predetermined value is an early reference value less than an operating toner density value, and the threshold value is a value in the range of 30 seconds to 60 seconds.

10. The device for detecting a life of a developer for an image forming apparatus of claim 1, wherein the control unit is further configured to store the toner density recovery time in a memory device each time a toner source is replaced, and to evaluate the life of the developer based on the stored time density recovery times.

11. The device for detecting a life of a developer for an image forming apparatus of claim 10, wherein the control unit is further configured to apply a regression analysis to the stored toner density recovery times to determine for which toner source replacement the toner density recovery time is predicted to reach a threshold indicative of the developer reaching a replacement point.

12. The device for detecting a life of a developer for an image forming apparatus of claim 11, wherein the control unit is further configured to generate a signal indicating when the developer is predicted to reach the threshold indicative of the replacement point.

13. The device for detecting a life of a developer for an image forming apparatus of claim 1, wherein the control unit is further configured to adjust the sensor output based on one or more detected environmental conditions, and uses the adjusted sensor output for determining the toner density recovery time.

14. The device for detecting a life of a developer for an image forming apparatus of claim 13, wherein the one or more environmental conditions include at least one of temperature, pressure, and humidity.

15. A device for detecting a life of a developer that is used in an image forming apparatus, comprising:
a sensor that detects a toner density of the developer and provides an output;
a control unit, coupled to the sensor, configured to determine a toner density recovery time, the toner density recovery time being a length of time form a first time that a developing device in the image forming apparatus begins operating after a new toner source is added to the image forming apparatus to a second time that the sensor output reaches a predetermined value, and to determine whether the developer has reached a predetermined replacement point based on the toner density recovery time.

16. The device for detecting a life of a developer for an image forming apparatus of claim 15, wherein the control unit is further configured to conclude that the developer has reached the replacement point if the toner density recovery time exceeds a threshold value.

17. The device for detecting a life of a developer for an image forming apparatus of claim 16, wherein the predetermined value is an operating toner density value, and the threshold value is a value in the range of about 100 seconds to 150 seconds.

18. The device for detecting a life of a developer for an image forming apparatus of claim 16, wherein the predetermined value is an operating toner density value, and the threshold value is a value determined by multiplying a time factor by a toner density recovery time of a first toner source.

19. The device for detecting a life of a developer for an image forming apparatus of claim 18, wherein the time factor is in the range of about 2 to 3.

20. The device for detecting a life of a developer for an image forming apparatus of claim 16, wherein the predetermined value is an early reference value less than an operating toner density value, and the threshold value is a value in the range of 30 seconds to 60 seconds.

21. The device for detecting a life of a developer for an image forming apparatus of claim 15, wherein the control unit is further configured to store the toner density recovery time in a memory device each time a toner source is replaced, and to evaluate the life of the developer based on the stored time density recovery times.

22. The device for detecting a life of a developer for an image forming apparatus of claim 21, wherein the control unit is further configured to apply a regression analysis to the stored toner density recovery times to determine for which toner source replacement the toner density recovery time is predicted to reach a threshold indicative of the developer reaching a replacement point.

23. The device for detecting a life of a developer for an image forming apparatus of claim 22, wherein the control unit is further configured to generate a signal indicating when the developer is predicted to reach the threshold indicative of the replacement point.

24. The device for detecting a life of a developer for an image forming apparatus of claim 15, wherein the control unit is further configured to adjust the sensor output based on one or more detected environmental conditions, and uses the adjusted sensor output for determining the toner density recovery time.

25. The device for detecting a life of a developer for an image forming apparatus of claim 24, wherein the one or more environmental conditions include at least one of temperature, pressure, and humidity.

26. A device for detecting a life of a developer that is used in an image forming apparatus, comprising:
a sensor that detects a toner density of the developer and provides an output; and
a control unit, coupled to the sensor, configured to read the sensor output at a predetermined time after a developing device in the image forming apparatus begins operating after a new toner source is added to the image forming apparatus, and to determine whether the developer has reached a predetermined replacement point based on the sensor output.

27. The device for detecting a life of a developer for an image forming apparatus of claim 26, wherein the predetermined time is about 10 to 30 seconds.

28. The device for detecting a life of a developer for an image forming apparatus of claim 26, wherein the control unit is programmed to conclude that the life of the developer is expired when the output of the sensor exceeds a predetermined value of about 2.8 to 2.9 volts at the predetermined time.

29. The device for detecting a life of a developer for an image forming apparatus of claim 26, wherein the control unit is programmed to conclude that the life of the developer is expired when a difference between a toner empty value and the output of the sensor is less than a value determined by multiplying a voltage factor by a difference between the toner empty value and an output of the sensor for a first toner source.

30. The device for detecting a life of a developer for an image forming apparatus of claim 29, wherein the voltage factor is in the range of about ¼ to ⅓.

31. The device for detecting a life of a developer for an image forming apparatus of claim 26, wherein the control unit is further configured to store the sensor output read at the predetermined time in a memory device each time a toner source is replaced, and to evaluate the life of the developer based on the stored sensor outputs.

32. The device for detecting a life of a developer for an image forming apparatus of claim 31, wherein the control unit is further configured to apply a regression analysis to the stored sensor outputs to determine for which toner source replacement the sensor output is predicted to reach a threshold indicative of the developer reaching a replacement point.

33. The device for detecting a life of a developer for an image forming apparatus of claim 32, wherein the control unit is further configured to generate a signal indicating when the developer is predicted to reach the threshold indicative of the replacement point.

34. The device for detecting a life of a developer for an image forming apparatus of claim 26, wherein the control unit is further configured to adjust the detected sensor output based on one or more detected environmental conditions, and uses the adjusted sensor output to determine whether the developer has reached a predetermined replacement point.

35. The device for detecting a life of a developer for an image forming apparatus of claim 34, wherein the one or more environmental conditions include at least one of temperature, pressure, and humidity.

36. A device for detecting a life of a developer for an image forming apparatus, comprising:
a sensor for detecting a toner density of the developer and provides an output; and
a control unit, coupled to the sensor, configured to read the sensor output after a new toner cartridge is installed in the image forming apparatus, and to forecast the life of the developer based on the sensor output.

37. The device for detecting a life of a developer for an image forming apparatus of claim 36, wherein the control unit is further configured to conclude that the life of the developer is expired when the sensor output exceeds a predetermined value.

38. The device for detecting a life of a developer for an image forming apparatus of claim 36, wherein a prior sensor output is associated with adding a prior new toner source and a current sensor output is associated with adding a current new toner source, and wherein the control unit is further configured to calculate a variation between the prior sensor output and the current sensor output, and calculate an expected number of toner source replacements remaining until a future output of the sensor reaches a predetermined value based on the current sensor output and the variation.

39. The device for detecting a life of a developer for an image forming apparatus of claim 36, wherein the control unit is further configured to adjust the detected sensor output based on one or more detected environmental conditions, and uses the adjusted sensor output for determining the toner density recovery time.

40. The device for detecting a life of a developer for an image forming apparatus of claim 39, wherein the one or more environmental conditions include at least one of temperature, pressure, and humidity.
